(19) United States
(12) Patent Application Publication
(10) Pub. No.: US 2024/0281079 A1
(43) Pub. Date: Aug. 22, 2024

(54) MANAGEMENT DEVICE, MANAGEMENT METHOD, AND PROGRAM

(71) Applicant: NIPPON TELEGRAPH AND TELEPHONE CORPORATION, Tokyo (JP)

(72) Inventor: Takahiro KUSABUKA, Tokyo (JP)

(73) Assignee: NIPPON TELEGRAPH AND TELEPHONE CORPORATION, Tokyo (JP)

(21) Appl. No.: 18/570,057

(22) PCT Filed: Jun. 15, 2021
(86) PCT No.: PCT/JP2021/022750

§ 371 Date: Dec. 13, 2023

(51) Int. Cl. G06F 3/041; G06F 9/451

(52) U.S. Cl. CPC G06F 3/041; G06F 9/451; G06F 2203/04102

(57) ABSTRACT

A management device 100 for managing a timing of discarding a user interface includes a setting information database 122 for storing setting information related to the timing, an operation detection unit 111 that detects an operation to the user interface and generates operation detection information, an operation history information database 121 for storing operation history information related to a history of the operation, and a management unit 112 that determines whether or not to discard the user interface on the basis of the setting information, the operation detection information, and the operation history information.

### TECHNICAL FIELD

The present invention relates to a management device, a management method, and a program.

### BACKGROUND ART

In order to prevent the spread of infectious diseases, it is important that the private space is not contaminated. When a user touches a smartphone or an earphone with a hand touching public equipment when the user goes out, the private space may be contaminated through the smartphone or the earphone.

For example, PTL 1 discloses a technique for enabling a user to operate a terminal without directly touching the terminal by using a user interface having a pressure-sensitive input portion in which a conductive polymer and a binder resin are coated on a fiber or a fabric.

### CITATION LIST

### Patent Literature

[PTL 1] Japanese Patent Application Publication No. 2014-228959

### SUMMARY OF INVENTION

### Technical Problem

However, in the case of using the user interface as disclosed in PTL 1, the user has to appropriately wash the user interface at a timing. Therefore, there is a method of always keeping the user interface clean by discarding it every time the user interface is used like a mask. However, this approach requires the user to remember for himself whether or not he has used the user interface, that is, whether or not the user interface he is about to use is in a clean state. If the user forgets to do this, it is possible that the user may accidentally throw away a user interface that has not been used, or that the user forgets to discard the user interface after using it. That is, there was a desire to dispose of the user interface at the appropriate time so that the user can always touch the user interface in a clean condition.

An object of the present disclosure having been devised in consideration of the circumstances, is to provide a management device, a management method, and a program that can appropriately manage the timing of discarding a user interface.

### Solution to Problem

A management device according to one embodiment, which manages a timing of discarding a user interface, the management device comprising: a setting information database for storing setting information related to the timing; an operation detection unit that detects an operation to the user interface and generates operation detection information; an operation history information database for storing operation history information related to a history of the operation; and a management unit that determines whether or not to discard the user interface on the basis of the setting information, the operation detection information, and the operation history information.

A management method according to one embodiment, which manages a timing of discarding a user interface, the management method including: a step of storing setting information related to the timing; a step that detects a position of the user interface and generates position detection information; a step of storing position history information related to a history of the position; and a step that determines whether or not to discard the user interface on the basis of the setting information, the position detection information, and the position history information.

A program according to one embodiment causes a computer to function as the management device described above.

### Advantageous Effects of Invention

According to the present disclosure, it is possible to provide a management device, a management method, and a program capable of appropriately managing a timing of discarding a user interface.

### BRIEF DESCRIPTION OF DRAWINGS

FIG. 1 is a diagram showing an example of the configuration of the management device according to a first embodiment.

FIG. 2 is a diagram showing an example of each piece of data according to the first embodiment.

FIG. 3 is a diagram showing an example of each piece of data according to the first embodiment.

FIG. 4 is a flowchart showing an example of a management method according to the first embodiment.

FIG. 5 is a diagram showing an example of a configuration of a management device according to a modified example 1.

FIG. 6 is a diagram showing an example of each piece of data according to the modified example 1.

FIG. 7 is a flowchart showing an example of a management method according to the modified example 1.

FIG. 8 is a diagram showing an example of a configuration of a management device according to a modified example 2.

FIG. 9 is a flowchart showing an example of a management method according to the modified example 2.

FIG. 10 is a diagram showing an example of a configuration of a management device according to a modified example 3.

FIG. 11 is a flowchart showing an example of a management method according to the modified example 3.

FIG. 12 is a diagram showing an example of the configuration of the management device according to a second embodiment.

FIG. 13 is a diagram showing an example of each piece of data according to the second embodiment.

FIG. 14 is a diagram showing an example of each piece of data according to the second embodiment.

FIG. 15 is a flowchart showing an example of a management method according to the second embodiment.

FIG. 16 is a diagram showing an example of the configuration of the management device according to a third embodiment.

FIG. 17 is a flowchart showing an example of a management method according to the third embodiment.

### DESCRIPTION OF EMBODIMENTS

Hereinafter, modes for carrying out the present invention will be described in detail with reference to the drawings. In principle, the same components are denoted by the same reference signs, and redundant description is omitted.

### First Embodiment

### <Structure of Management Device>

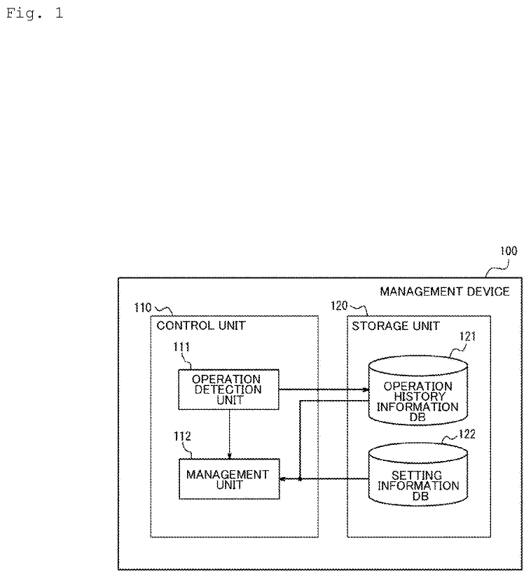

First, an example of a configuration of a management device according to a first embodiment will be described with reference to FIGS. 1 to 3.

A management device 100 is a device for managing the timing of discarding a user interface (UI). A user can perform the user's operation by using the UI, for example, a portable terminal such as a notebook PC (personal computer) or a smart phone, a tablet terminal or the like can be operated. The UI may be at least disposable, and its form is not particularly limited. The UI includes, for example, a cloth-like touch panel type device attachable to and detachable from clothes, a string type device wound around a bobbin and the like.

The management device 100 is not particularly limited in its arrangement place, and may be incorporated in a notebook PC, a portable terminal, a tablet terminal, etc., or these devices may be connected to be communicable by wire or wireless. Alternatively, the management device 100 may be connected to the UI so as to be able to communicate with the UI by wire or wireless.

The management device 100 includes a control unit 110 and a storage unit 120.

A control unit 110 may be constituted by dedicated hardware or constituted by a general-purpose processor or a processor specialized for specific processing. The control unit 110 includes an operation detection unit 111 and a management unit 112.

The storage unit 120 includes one or more memories and may include, for example, a semiconductor memory, a magnetic memory, an optical memory, and so on. Each of the memories included in the storage unit 120 may function as, for example, a main storage apparatus, an auxiliary storage apparatus, or a cache memory. Each memory does not necessarily have to be provided inside the management device 100, and may be a configuration of providing outside the management device 100. The storage unit 120 stores arbitrary information used for the operation of the management device 100. In addition to the above, the storage unit 120 stores various programs, data, or the like. The storage unit 120 includes an operation history information database 121 and a setting information database 122.

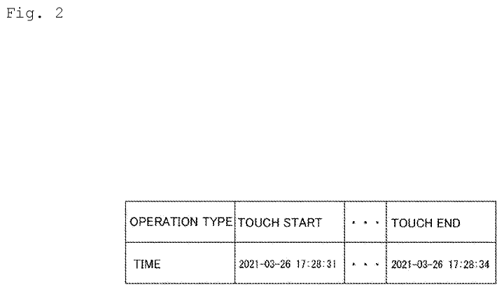

The operation history information database 121 stores operation history information related to a history of an operation to the UI. The operation history information is information input from the operation detection unit 111. As shown in FIG. 2, the operation history information is information indicating “operation type” including, for example, a start of a touch operation on the UI, an end of a touch operation on the UI, and the like. The operation history information is information expressing a “time” including, for example, “2021-03-26 17:28:31” of the start time of the touch operation on the UI, “2021-03-26 17:28:34” of the end time of the touch operation on the UI, and the like.

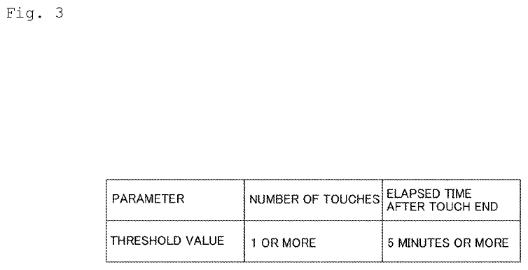

The setting information database 122 stores setting information related to the timing of discarding the UI. The setting information is preset information. As shown in FIG. 3, the setting information is information indicating “parameters” including, for example, the number of touch operations on the UI, the elapsed time from the end of the touch operation on the UI, and the like. Also, the setting information is information indicating “threshold” including, for example, “1 or more” times of the number of times of touch operation on the UI, “5 minutes or more” of the elapsed time from the end of the touch operation on the UI, and the like.

An operation detection unit 111 detects an operation to the UI and generates operation detection information. The operation detection unit 111 outputs the operation detection information to the management unit 112. Also, the operation detection unit 111 stores the operation detection information in an operation history information database 121. Operation to the UI mean operations in which at least the user is in contact with the UI, for example, the user pushing the UI, the user scrolling the UI, the user pinching the UI, the user pulling the UI, and so on.

The management unit 112 determines whether or not to discard the UI on the basis of the setting information stored in the setting information database 122, the operation detection information input from the operation detection unit 111, and the operation history information stored in the operation history information database 121.

The management device 100 according to the first embodiment determines whether or not to discard a UI on the basis of the setting information, the operation detection information, and the operation history information. By applying the management device 100, the timing of discarding the UI can be appropriately managed, so that a user can use the UI in a clean state.

In addition, it avoids conventional problems such as the user having to remember whether or not the UI has already been touched, the user always having to throw away the UI if the user forgets whether or not the user has used the UI, which is costly, the user having to cleanse the UI from time to time, etc. Therefore, the user can always touch the UI in a clean condition without depending on the user memory of the UI usage, differences in awareness of cleanliness among users, and the like. Thus, the management device 100 effective for the countermeasure against infectious diseases can be realized.

### <Management Method>

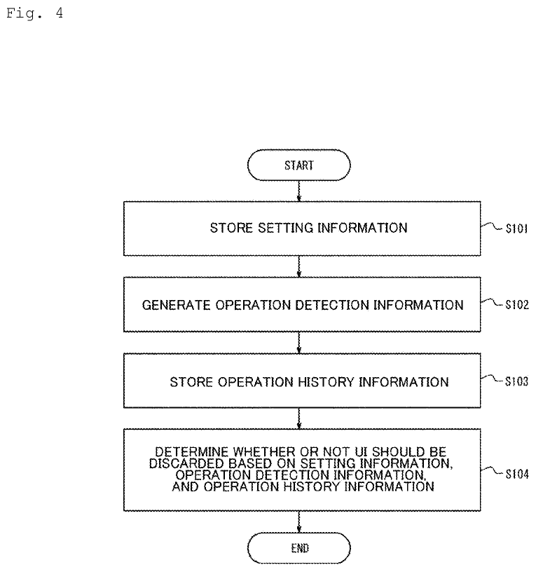

Next, an example of the management method according to the first embodiment will be described with reference to FIG. 4.

In step 101, the setting information database 122 stores setting information relating to the timing of discarding the UI.

In step 102, the operation detection unit 111 detects an operation to the UI and generates operation detection information. The operation detection unit 111 outputs the operation detection information to the management unit 112.

In step 103, the operation history information database 121 stores operation history information related to the history of the operation to the UI.

In step 104, the management unit 112 determines whether or not to discard the UI based on the setting information stored in the setting information database 122, the operation detection information input from the operation detection unit 111, and the operation history information stored in the operation history information database 121.

By applying the management method according to the first embodiment, the timing of discarding the UI can be appropriately managed.

### Modified Example 1

### <Structure of Management Device>

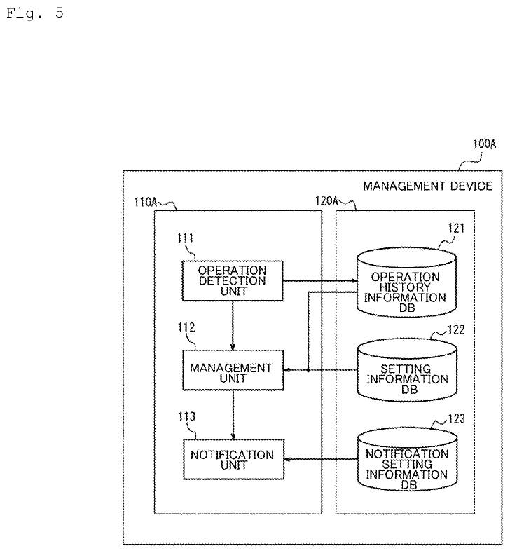

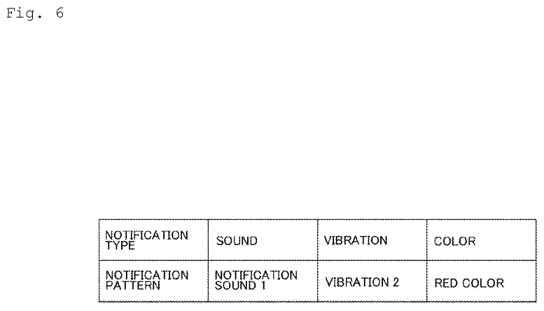

An example of a configuration of a management device 100A according to a modified example 1 will be described with reference to FIG. 5 or FIG. 6.

The difference between the management device 100A pertaining to the modified example 1 and the management device 100 of the first embodiment is that the management device 100 of the first embodiment does not include a notification unit and a notification setting information database, whereas the management device 100A of the modified example 1 includes a notification unit and a notification setting information database. Since other configurations are the same, redundant explanations are omitted.

The management device 100A includes a control unit 110A and a storage unit 120A. The control unit 110A includes the operation detection unit 111, the management unit 112, and a notification unit 113. The storage unit 120A includes the operation history information database 121, the setting information database 122, and a notification setting information database 123.

The notification setting information database 123 stores notification setting information related to notification contents for notifying the outside of the timing of discarding the UI. The notification setting information is preset information. As shown in FIG. 6, the notification setting information is information that indicates the “notification type” including, for example, “sound”, “vibration”, and “color”, and the like. Also, the notification setting information is information that indicates the “notification pattern” including, for example, “notification sound 1”, “vibration 2”, and “red color”, and the like. The notification setting information is not limited to this information. For example, the information indicating the “notification type” may be “light” and the information indicating the “notification pattern” may be “blinking LED lamp”.

The management unit 112 determines whether the UI should be discarded of or not on the basis of the setting information stored in the setting information database 122, the operation detection information input from the operation detection unit 111, and the operation history information stored in the operation history information database 121, and outputs the determination result to a notification unit 113. For example, when determining that the UI should be discarded, the management unit 112 outputs a determination result indicating the timing of discarding the UI to the notification unit 113. For example, if management unit 112 determines that the UI is not discarded, a determination result indicating that it is not the timing of discarding the UI is output to notification unit 113.

When it is determined by the management unit 112 that the UI is to be discarded, the notification unit 113 executes the set notification contents to notify the outside world that it is the timing of discarding the UI, based on the notification setting information stored in the notification setting information database 123. There is no particular limitation on the configuration of the notification unit 113. The notification unit 113 may be, for example, a speaker, a vibration device, or an LED lamp mounted on a portable terminal. The notification unit 113 may be, for example, a coating device mounted on a UI. The notification unit 113 may be, for example, sunglasses worn by a user.

For example, if the notification unit 113 is a speaker, the notification unit 113 plays the notification sound 1 when the determination result indicating that it is the timing of discarding the UI is input from the management unit 112, and does not output sound when a determination result indicating that it is not the timing of discarding the UI is input from the management unit 112.

For example, if the notification unit 113 is a vibration device, the notification unit 113 vibrates with vibration 2 when a determination result indicating that it is the timing of discarding the UI is input from the management unit 112, and does not vibrate when a determination result indicating that it is not the timing of discarding the UI is input from the management unit 112.

For example, if the notification unit 113 is a coating device, the notification unit 113 make turn the cloth or string that is the UI red color by temperature-sensitive ink when a determination result indicating the timing of discarding the UI is input from the management unit 112, and when the determination result indicating that it is not the timing of discarding the UI is input from the management unit 112, the notification unit 113 does not discolor cloth or string as the UI.

The management device 100A according to the modified example 1 determines whether the UI should be discarded of or not on the basis of the setting information, the operation detection information, and the operation history information, when determining that the UI should be discarded, the timing of discarding the UI is notified to the outside. By applying the management device 100, the timing of discarding the UI can be appropriately managed and notified to the outside, so that a user can use the UI in a clean state.

### <Management Method>

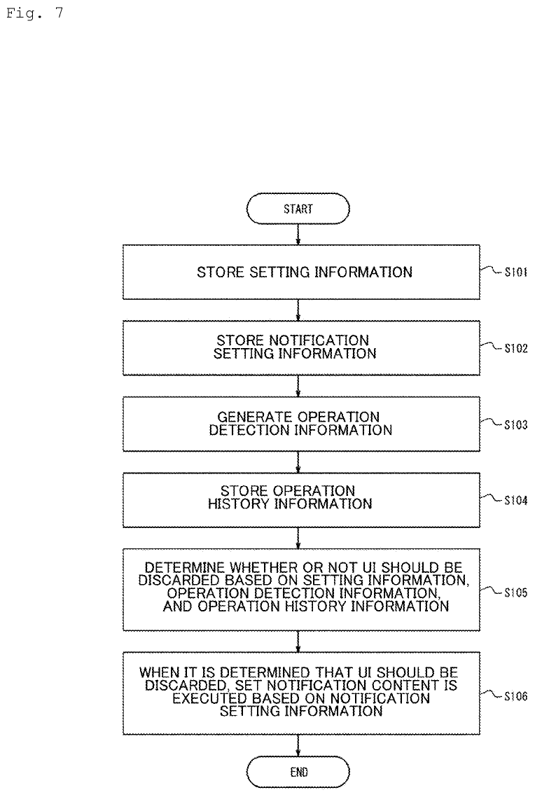

An example of a management method according to the modified example 1 will be described with reference to FIG. 7.

In step 101, the setting information database 122 stores setting information relating to the timing of discarding the UI.

In step 102, the notification setting information database 123 stores notification setting information related to notification contents for notifying the timing of discarding the UI to the outside.

In step 103, the operation detection unit 111 detects an operation to the UI and generates operation detection information. The operation detection unit 111 outputs the operation detection information to the management unit 112.

In step 104, the operation history information database 121 stores operation history information related to the history of the operation to the UI.

In step 105, the management unit 112 determines whether or not to discard the UI based on the setting information stored in the setting information database 122, the operation detection information input from the operation detection unit 111, and the operation history information stored in the operation history information database 121. Then, the management unit 112 outputs the determination result to the notification unit 113.

In a step 106, when the determination result input from the management unit 112 is the determination result indicating the timing of discarding the UI, the notification unit 113 executes the set notification contents to notify the timing of discarding the UI to the outside, based on the notification setting information stored in the notification setting information database 123.

By applying the management method according to the modified example 1, the timing of discarding the UI can be appropriately managed and notified to the outside.

### Modified Example 2

### <Structure of Management Device>

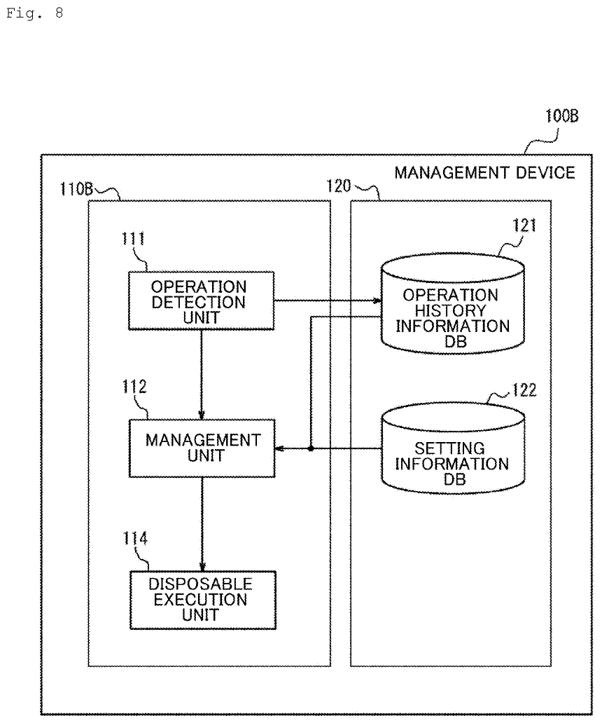

An example of a configuration of a management device 100B according to a modified example 2 will be described with reference to FIG. 8.

The management device 100B according to the modified example 2 differs from the management device 100 according to the first embodiment in that the management device 100 according to the first embodiment does not include a disposable execution unit, whereas the management device 100B according to the modified example 2 includes a disposable execution unit. Since other components are similar, redundant descriptions may be omitted.

The management device 100B includes a control unit 110B and a storage unit 120. The control unit 110B includes an operation detection unit 111, a management unit 112, and a disposable execution unit 114. The storage unit 120 includes an operation history information database 121 and a setting information database 122.

A management unit 112 determines whether the UI should be discarded of or not on the basis of the setting information stored in the setting information database 122, the operation detection information input from the operation detection unit 111, and the operation history information stored in the operation history information database 121, and outputs the determination result to the disposable execution unit 114. For example, when determining that the UI should be discarded, the management unit 112 outputs a determination result indicating the timing of discarding the UI to the disposable execution unit 114. For example, if the management unit 112 determines that the UI is not to be disposed of, it outputs a determination result to the disposable execution unit 114 indicating that the timing of discarding the UI is not a good timing.

When the management unit 112 determines that the UI should be discarded, the disposable execution unit 114 executes an operation for discarding the UI. The configuration of the disposable execution unit 114 is not particularly limited as long as it is at least a device capable of automatically executing the disposable of the UI. The disposable execution unit 114 may be, for example, a servo motor to which a blade capable of cutting a string is attached, a robot having an arm capable of winding a cloth, and the like.

For example, when the disposable execution unit 114 is a servo motor, the disposable execution unit 114 cuts a string that is the UI when a determination result indicating the timing of discarding the UI is input from the management unit 112, and when the determination result indicating that the timing is not the timing of discarding the UI is input from the management unit 112, the string as the UI is not cut.

For example, when the disposable execution unit 114 is a robot arm, the disposable execution unit 114 winds up a cloth as the UI and replaces it with a new cloth when a determination result indicating the timing of discarding the UI is input from the management unit 112, and when a determination result indicating the timing of discarding the UI is input from the management unit 112, the cloth as the UI is not wound up.

A management device 100B according to a modified example 2 determines whether the UI should be discarded of or not on the basis of the setting information, the operation detection information, and the operation history information, and when it is determined that the UI is discarded, disposable of the UI is executed. By applying the management device 100, the timing of discarding the UI is appropriately managed, and an action in executing the disposal of the UI can be automated, so that a user can use the UI in a clean state.

### <Management Method>

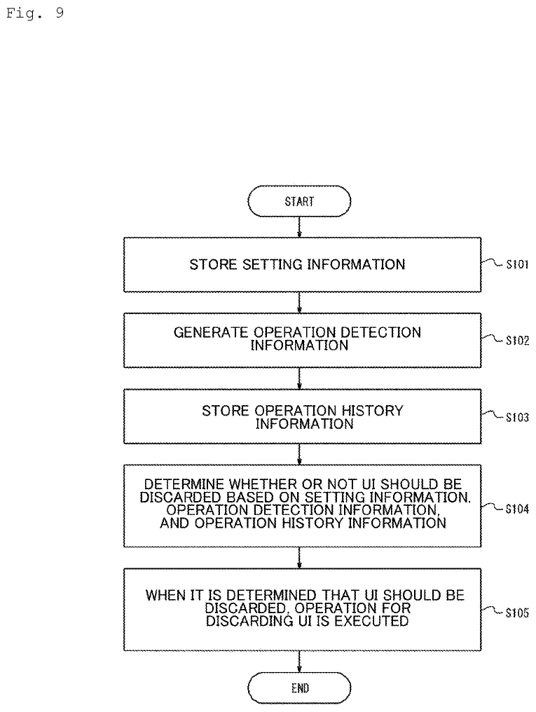

An example of a management method according to the modified example 2 will be described with reference to FIG. 9.

In step 101, the setting information database 122 stores setting information relating to the timing of discarding the UI.

In step 102, the operation detection unit 111 detects an operation to the UI and generates operation detection information. The operation detection unit 111 outputs the operation detection information to the management unit 112.

In step 103, the operation history information database 121 stores operation history information related to the history of the operation to the UI.

In step 104, the management unit 112 determines whether or not to discard the UI based on the setting information stored in the setting information database 122, the operation detection information input from the operation detection unit 111, and the operation history information stored in the operation history information database 121. Then, the management unit 112 outputs the determination result to a disposable execution unit 114.

In step 105, if the determination result input from the management unit 112 is a determination result indicating the timing of discarding the UI, the disposable execution unit 114 executes an operation for discarding the UI.

By applying the management method according to the modified example 2, the timing of discarding the UI can be appropriately managed, and the action in executing the disposal of the UI can be automated.

### Modified Example 3

### <Structure of Management Device>

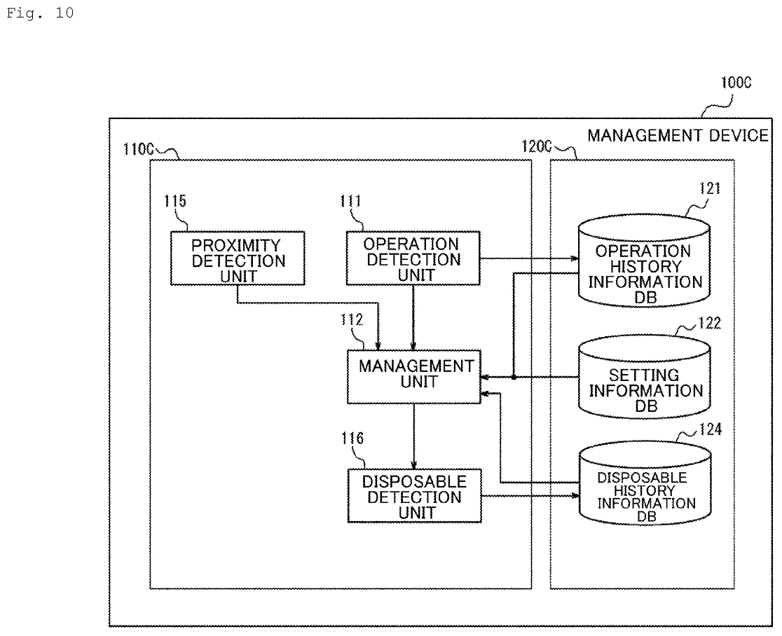

An example of a configuration of a management device 100C according to a modified example 3 will be described with reference to FIG. 10.

The management device 100C according to a modified example 3 differs from the management device 100 according to the first embodiment in that the management device 100 according to the first embodiment does not include a proximity detection unit, a disposable detection unit, and a disposable history information database, the management device 100C according to the modified example 3 includes a proximity detection unit, a disposable detection unit, and a disposable history information database. Since other configurations are the same, redundant explanations are omitted.

The management device 100C includes a control unit 110C and a storage unit 120C. The control unit 110C includes an operation detection unit 111, a management unit 112, a proximity detection unit 115, a disposable detection unit 116. A storage unit 120C includes an operation history information database 121, a setting information database 122, and a disposable history information database 124.

A proximity detection unit 115 detects proximity to the UI and generates proximity detection information. A proximity detection unit 115 outputs proximity detection information to a management unit 112. The approach to the UI means a state in which the user and the UI are close to each other without contacting each other, for example, such as when the user's finger approaches a distance of about several cm from the UI.

The management unit 112 determines whether the operation is to the UI or proximity to the UI on the basis of the operation detection information input from the operation detection unit 111 and the proximity detection information input from the proximity detection unit 115.

If the management unit 112 determines that the operation is to the UI, it determines whether the UI should be discarded of or not on the basis of the setting information stored in the setting information database 122, the operation detection information input from the operation detection unit 111, and the operation history information stored in the operation history information database 121, and outputs the determination result to a disposable detection unit 116. For example, when determining that the UI should be discarded, the management unit 112 outputs a determination result indicating the timing of discarding the UI to the disposable detection unit 116. For example, if management unit 112 determines that the UI is not to be discarded, it outputs a determination result to disposable detection unit 116 indicating that it is not the timing of discarding the UI.

If management unit 112 determines that it is proximity to the UI, it determines whether the UI should be disposed of or not on the basis of the setting information stored in the setting information database 122, the proximity detection information input from proximity detection unit 115, and the disposable history information stored in the disposable history information database 124, and the determination result is output to the disposable detection unit 116. For example, when determining that the UI should be discarded, the management unit 112 outputs a determination result indicating the timing of discarding the UI to the disposable detection unit 116. For example, if management unit 112 determines that the UI is not to be discarded, it outputs a determination result to disposable detection unit 116 indicating that it is not the timing of discarding the UI. Before the user touches the UI, the management unit 112 determines whether or not to discard the UI, thereby preventing the user from touching the UI in a dirty state.

A disposable detection unit 116 detects whether or not the disposable of the UI has been executed, and outputs a detection result to a disposable history information database 124. For example, when the management unit 112 determines that the UI should be discarded, the disposable detection unit 116 detects that the disposable of the UI has been executed. For example, when the management unit 112 determines that the UI is not discarded, the disposable detection unit 116 detects that the disposable of the UI is not executed.

A disposable history information database 124 stores disposable history information on a history of execution of the disposable of the UI. The disposable history information is information input from a disposable detection unit 116. The disposable history information is, for example, information indicating that the disposable of the predetermined UI is executed. Further, the disposable history information is, for example, information indicating that the disposable of the predetermined UI has not been executed.

A management device 100C according to a modified example 3 determines whether the operation is to the UI or proximity to the UI on the basis of the operation detection information and the proximity detection information. Then, if the management device 100C determines that the operation is to the UI, it determines whether the UI should be discarded of or not on the basis of the setting information, the operation detection information, and the operation history information, and detects execution of the UI discard when determining that the UI should be discarded. Alternatively, if the management device 100C determines that the user is close to the UI, it determines whether the UI should be discarded of or not on the basis of the setting information, the proximity detection information, and the disposable history information, and detects execution of the UI discard when determining that the UI should be discarded. By applying the management device 100C, the timing of discarding the UI can be appropriately managed, so that a user can use the UI in a clean state. Also, by applying the management device 100C, it is estimated that the user is going to contact the UI, and the UI can be appropriately discarded before the user contacts the UI, even if the user forgets to discard the UI after using the UI, it is possible to prevent the user from touching the UI in a dirty state.

### <Management Method>

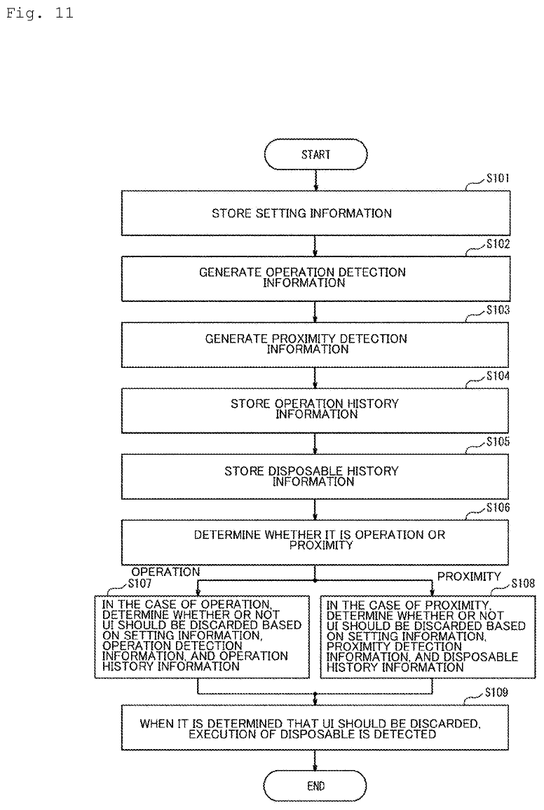

An example of a management method according to the modified example 3 will be described with reference to FIG. 11.

In step 101, the setting information database 122 stores setting information relating to the timing of discarding the UI.

In step 102, the operation detection unit 111 detects an operation to the UI and generates operation detection information. The operation detection unit 111 outputs the operation detection information to the management unit 112.

In step 103, the proximity detection unit 115 detects proximity to the UI and generates proximity detection information. A proximity detection unit 115 outputs proximity detection information to a management unit 112.

In step 104, the operation history information database 121 stores operation history information related to the history of the operation to the UI.

In step 105, the disposable history information database 124 stores disposable history information related to the history of execution of the disposable of the UI.

In step 106, the management unit 112 determines whether the operation is to the UI or proximity to the UI on the basis of the operation detection information and the proximity detection information. If management unit 112 determines that the operation is to the UI, it performs processing of step 107. When it is determined that the user is close to the UI, the management unit 112 performs the processing of step 108.

In step 107, the management unit 112 determines whether or not to discard the UI based on the setting information stored in the setting information database 122, the operation detection information input from the operation detection unit 111, and the operation history information stored in the operation history information database 121. Then, the management unit 112 outputs the determination result to the disposable detection unit 116.

In step 108, the management unit 112 determines, based on the setting information stored in the setting information database 122, the proximity detection information input from the proximity detection unit 115, and the disposable history information stored in the disposable history information database 124, whether to dispose of the UI before the user contacts the UI. Then, the management unit 112 outputs the determination result to the disposable detection unit 116.

In step 109, if the determination result input from the management unit 112 is the determination result indicating the timing of discarding the UI, the disposable detection unit 116 detects the discard execution.

By applying the management method according to the modified example 3, the timing of discarding the UI can be appropriately managed. Further, since the user can be prevented from contacting with the UI in a dirty state, a management method particularly effective for a countermeasure against infectious can be realized.

### Second Embodiment

### <Structure of Management Device>

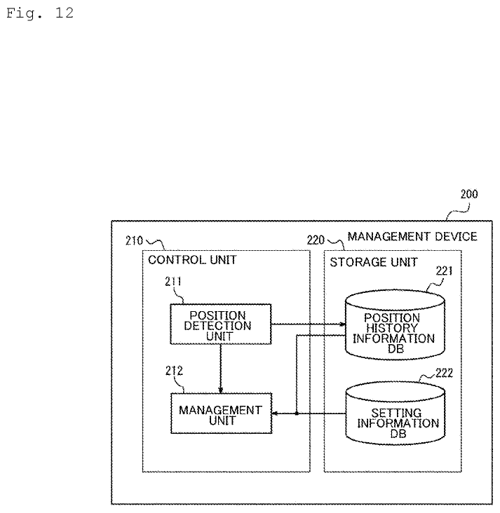

An example of a configuration of a management device 200 according to a second embodiment will be described with reference to FIGS. 12 to 14.

The management device 200 includes a control unit 210 and a storage unit 220. The control unit 210 includes the position detection unit 211 and the management unit 212. The storage unit 220 includes a position history information database 221 and a setting information database 222.

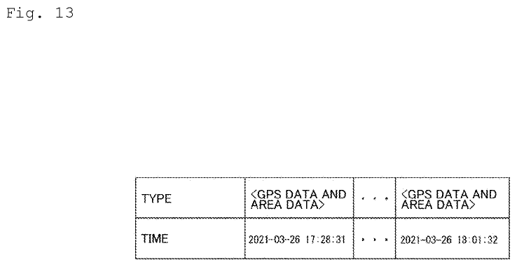

A position history information database 221 stores position history information related to the history of the position of the UI. The position history information is information input from a position detection unit 211. As shown in FIG. 13, the position history information is information indicating “position type” including, for example, GPS (Global Positioning System) data, area data, and the like. The location history information is also information indicating “time” including, for example, the time the UI arrived at the given position “2021-03-26 17:28:31”, the time the UI departed the given position “2021-03-26 18:01:32”, and the like.

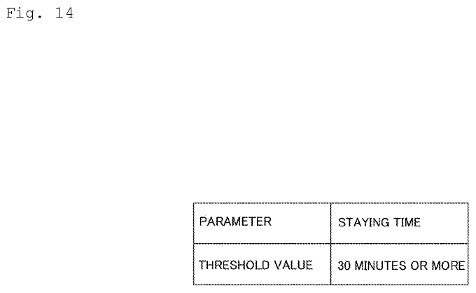

The setting information database 222 stores setting information related to the timing of discarding the UI. The setting information is preset information. As shown in FIG. 14, the setting information is information indicating “parameters” including, for example, a stay time when the UI stays at a predetermined position. The setting information is, for example, information indicating a “threshold” including “30 minutes” or more and the like of a stay time when the UI stays at a predetermined position.

A position detection unit 211 detects the position of the UI on the basis of the GPS data and the area data, and generates position detection information. The position detection unit 211 outputs the position detection information to the management unit 112. The position detection unit 211 stores the position detection information in a position history information database 221. The position of the UI means, for example, a position of the UI when the user enters the supermarket, a position of the UI when the user leaves the supermarket, or the like, where the UI exists at present.

The management unit 212 determines whether or not to discard the UI on the basis of the setting information stored in the setting information database 222, the position detection information input from the position detection unit 211, and the position history information stored in the position history information database 221.

A management device 200 according to a second embodiment determines whether or not to discard the UI on the basis of the setting information, the position detection information, and the position history information. By applying the management device 200, the timing of discarding the UI can be appropriately managed, so that a user can use the UI in a clean state.

In addition, since the supermarket has many people and has a high infection risk, the UI is discarded at a timing when the user leaves the supermarket, and since the park has few people and has a low infection risk, the UI is not disposable even after the user stays in the park, The timing of discarding the UI can be appropriately managed according to the position of the UI. Thus, the management device 200 effective for the countermeasure against infectious diseases can be realized.

### <Management Method>

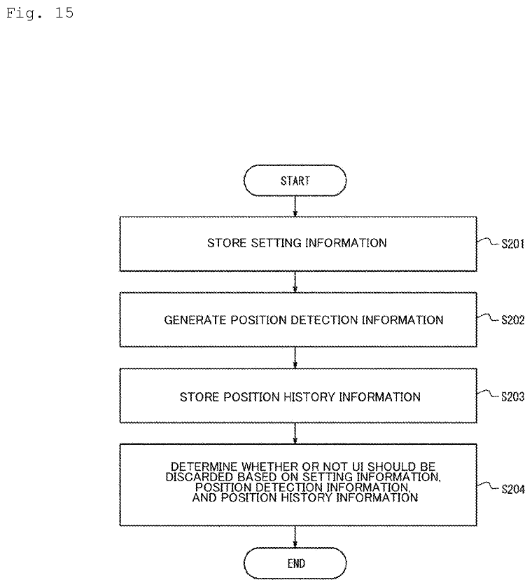

An example of a management method according to the second embodiment will be described with reference to FIG. 15.

In step 201, the setting information database 222 stores setting information relating to the timing of discarding the UI.

In step 202, the position detection unit 211 detects the position of the UI on the basis of the GPS data and the area data, and generates position detection information. The position detection unit 211 outputs the position detection information to the management unit 212.

In step 203, the position history information database 221 stores position history information related to the history of the position of the UI.

In a step 204, the management unit 212 determines whether or not the UI is discarded on the basis of the setting information stored in the setting information database 222, the position detection information input from the position detection unit 211, and the position history information stored in the position history information database 221.

By applying the management method according to the second embodiment, the timing of discarding the UI can be appropriately managed.

### Third Embodiment

### <Structure of Management Device>

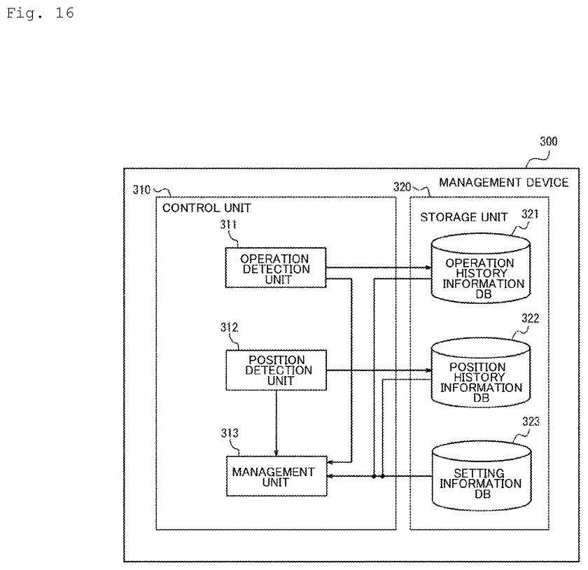

An example of a configuration of a management device according to a third embodiment will be described with reference to FIG. 16.

A management device 300 includes a control unit 310 and a storage unit 320. The control unit 310 includes an operation detection unit 311, a position detection unit 312, and a management unit 313. A storage unit 320 includes an operation history information database 321, a position history information database 322, and a setting information database 323.

The operation history information database 321 stores operation history information related to a history of an operation to the UI. The operation history information is information input from the operation detection unit 311.

A position history information database 322 stores position history information related to the history of the position of the UI. The position history information is information input from a position detection unit 312.

The setting information database 323 stores setting information related to the timing of discarding the UI. The setting information is preset information.

An operation detection unit 311 detects an operation to the UI and generates operation detection information. The operation detection unit 311 outputs the operation detection information to the management unit 313. Also, the operation detection unit 311 stores the operation detection information in an operation history information database 321.

A position detection unit 312 detects the position of the UI on the basis of the GPS data and the area data, and generates position detection information. The position detection unit 312 outputs the position detection information to the management unit 313. Also, The position detection unit 312 stores the position detection information in a position history information database 322.

A management unit 313 determines whether or not the UI is discarded on the basis of the setting information stored in a setting information database 323, the operation detection information input from an operation detection unit 311, the operation history information stored in an operation history information database 321, the position detection information input from a position detection unit 312, and the position history information stored in the position history information database 322.

For example, the management unit 313 determines that the UI should be discarded when determining that the UI should be discarded on the basis of the setting information stored in a setting information database 323, the operation detection information input from the operation detection unit 311, and the operation history information stored in the operation history information database 321, and when determining that the UI should be discarded on the basis of the setting information stored in the setting information database 323, position detection information input from the position detection unit 312, and the position history information stored in the position history information database 322. That is, when it is determined that both the operation condition and the position condition are satisfied, the management unit 313 determines that the UI is discarded.

For example, the management unit 313 determines that the UI should be discarded when determining that the UI should be discarded on the basis of the setting information stored in a setting information database 323, the operation detection information input from the operation detection unit 311, and the operation history information stored in the operation history information database 321, or when determining that the UI should be discarded on the basis of the setting information stored in the setting information database 323, position detection information input from the position detection unit 312, and the position history information stored in the position history information database 322. That is, the management unit 313 determines that the UI should be discarded when the operation condition is satisfied and the position condition is not satisfied. Alternatively, the management unit 313 determines that the UI should be discarded when the operation condition is not satisfied and the position condition is satisfied.

The management device 300 according to the third embodiment determines whether or not the UI is discarded on the basis of the setting information, the operation detection information, the operation history information, the position detection information, and the position history information. By applying the management device 300, the timing of discarding the UI can be appropriately managed, so that a user can use the UI in a clean state.

### <Management Method>

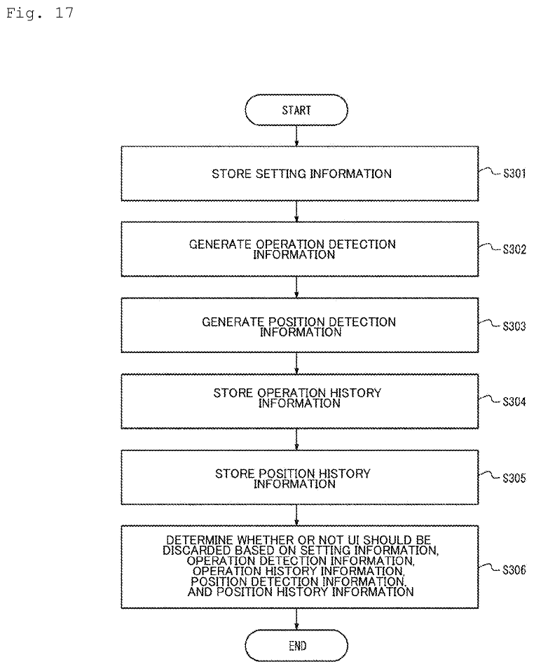

An example of the management method according to the third embodiment will be described with reference to FIG. 17.

In step 301, the setting information database 323 stores setting information relating to the timing of discarding the UI.

In step 302, the operation detection unit 311 detects an operation to the UI and generates operation detection information. The operation detection unit 311 outputs the operation detection information to the management unit 313.

In step 303, the position detection unit 312 detects the position of the UI on the basis of the GPS data and the area data, and generates position detection information. The position detection unit 312 outputs the position detection information to the management unit 313.

In step 304, the operation history information database 321 stores operation history information related to the history of the operation to the UI.

In step 305, the position history information database 322 stores position history information related to the history of the position of the UI.

In step 306, the management unit 313 determines whether or not the UI is discarded on the basis of the setting information stored in the setting information database 323, the operation detection information input from the operation detection unit 311, the operation history information stored in the operation history information database 321, the position detection information input from the position detection unit 312, and the position history information stored in the position history information database 322.

By applying the management method according to the third embodiment, the timing of discarding the UI can be appropriately managed.

### Modified Example

The present invention is not limited to the embodiments and modified examples described above. For example, various processing steps described above may not only be executed in a time series in accordance with the description but may also be executed in parallel or individually depending on a processing capacity of an apparatus executing the processing or as the need arises. Otherwise, various changes can be made as necessary without departing from the gist of the present invention.

### <Program and Recording Medium>

A computer capable of executing program instructions may be used to function as the above embodiments and variations. Here, the computer may be a general-purpose computer, dedicated computer, workstation, PC (Personal Computer), electronic notepad, etc. Program instructions may be program codes, code segments, etc. to perform the required tasks. Processors functioning as control units 110, 110A, 110B, 110C, 210, and 310 may be a CPU (Central Processing Unit), MPU (Micro Processing Unit), GPU (Graphics Processing Unit), DSP (Digital Signal Processor), SoC (System on a Chip), etc., and may be composed of multiple processors of the same or different types. The control units 110, 110A, 110B, 110C, 210, and 310 read programs from storage units 120, 120A, 120C, 220, and 320 and execute the programs to control each of the above configurations and perform various arithmetic operations. At least some of these processing contents may be realized in the hardware.

Referring to FIG. 4, a program for causing a computer to execute the management method described above, for example, includes at least a step (step 101) of a management method for managing of the timing of discarding the user interface and storing the setting information about the timing, a step (step 102) of detecting an operation to the user interface and generating operation the detection information, a step (step 103) of storing the operation history information related to the operation history, and a step (step 104) of determining whether or not to discard the user interface on the basis of the setting information, the operation detection information and the operation history information.

The program may also be recorded on a computer-readable recording medium. Using such a recording medium, it is possible to install the program on the computer. Here, the recording medium on which the program is recorded may be a non-transient recording medium. Even if the non-transient recording medium is a CD (Compact Disk)-ROM (Read-Only Memory), a DVD (Digital Versatile Disc)-ROM, a BD (Blu-ray (registered trademark) Disc)-ROM, or the like. This program can also be provided by downloading it via a network.

While embodiments have been described above as typical examples, it is obvious to a person skilled in the art that many modifications and substitutions can be made without departing from the gist and scope of the present disclosure. Therefore, the embodiments described above should not be construed to limit the present invention, and the present invention can be modified and changed in various ways without departing from the scope of the claims. For example, a plurality of component blocks shown in configuration diagrams of the embodiments may be combined into one component block, or one component block may be divided into component blocks. In addition, a plurality of steps shown in the flowcharts of the embodiments may be combined into one flowchart, or one step may be divided into steps.

### REFERENCE SIGNS LIST

100, 100A, 100B, 100C Management devices
110, 110A, 110B, 110C Control units
111 Operation detection unit
112 Management unit
113 Notification unit
114 Disposable execution unit
115 Proximity detection unit
116 Disposable detection unit
120, 120A, 120C Storage units
121 Operation history information database
122 Setting information database
123 Notification setting information database
124 Disposable history information database
200 Management device
210 Control unit
211 Position detection unit
212 Management unit
220 Storage unit
221 Position history information database
222 Setting information database
300 Management device
310 Control unit
311 Operation detection unit
312 Position detection unit
313 Management unit
320 Storage unit
321 Operation history information database
322 Position history information database
323 Setting information database

1. A device for managing, a timing of discarding a user interface, comprising a processor configured to execute operations comprising:
storing setting information of the timing in a setting information database, wherein the setting information of the timing includes a condition for discarding the user interface, and the user interface is disposable;
detecting an operation detection unit that detects an operation to the user interface;
generating operation detection information;
storing operation history information in an operation history information database, wherein the operation history information includes history data of the operation; and
determining whether to discard the user interface on the basis of the setting information, the operation detection information, and the operation history information.

2-3. (canceled)

4. A method for managing a timing of discarding a user interface, comprising:
storing setting information of the timing, wherein the setting information of the timing includes a condition for discarding the user interface, and the user interface is disposable;
detecting an operation to the user interface;
generating operation detection information;
storing operation history information, wherein the operation history information includes history data of the operation; and
determining whether to discard the user interface on the basis of the setting information, the operation detection information, and the operation history information.

5. A method for determining, a timing of discarding a user interface, comprising:
storing setting information related to the timing, wherein the setting information of the timing includes a condition for discarding the user interface, and the user interface is disposable;
detecting a position of the user interface;
generating position detection information;
storing position history information related to a history of the position; and
determining whether or not to discard the user interface on the basis of the setting information, the position detection information, and the position history information.

6-7. (canceled)

8. The device according to claim 1, wherein the user interface is replaceable with another user interface.

9. The device according to claim 1, wherein the user interface includes a cloth material.

10. The device according to claim 1, wherein the user interface enables interactively operating the device.

11. The device according to claim 1, wherein the user interface includes a detachable touch panel in a shape and a material of a cloth, and the detachable touch panel attaches to clothes as a wearable material.

12. The device according to claim 1, wherein the user interface includes a detachable touch panel in a shape of a string, wherein the detachable touch panel is wound around a bobbin of clothes.

13. The device according to claim 1, wherein the device communicates with the user interface over a wireless network.

14. The device according to claim 1, the processor further configured to execute operations comprising:
generating an alert signal to notify the determination to discard of the user interface.

15. The device according to claim 14, wherein the alert signal causes the user interface in a cloth material to indicate a predetermined color to alert for discarding the user interface.

16. The device according to claim 1, wherein the setting information includes a threshold time lapse and a threshold number of operating the user interface.

17. The method according to claim 4, wherein the user interface enables interactively operating a device.

18. The method according to claim 4, wherein the user interface includes a detachable touch panel in a shape and a material of a cloth, and the detachable touch panel attaches to clothes as a wearable material.

19. The method according to claim 4, wherein the user interface includes a detachable touch panel in a shape of a string, wherein the detachable touch panel is wound around a bobbin of clothes.

20. The method according to claim 4, wherein the user interface communicates over a wireless network.

21. The method according to claim 4, further comprising:
generating an alert signal to notify the determination to discard of the user interface, wherein the alert signal causes the user interface in a cloth material to indicate a predetermined color to alert for discarding the user interface.

22. The method according to claim 5, wherein the user interface includes a detachable touch panel in a shape and a material of a cloth, and the detachable touch panel attaches to clothes as a wearable material.

23. The method according to claim 5, wherein the user interface includes a detachable touch panel in a shape of a string, wherein the detachable touch panel is wound around a bobbin of clothes.

24. The method according to claim 5, further comprising:
generating an alert signal to notify the determination to discard of the user interface, wherein the alert signal causes the user interface in a cloth material to indicate a predetermined color to alert for discarding the user interface.
